(19) United States
(12) Patent Application Publication
(10) Pub. No.: US 2005/0241837 A1
(43) Pub. Date: Nov. 3, 2005

(54) Golf bunker trimmer with cutter guards

(76) Inventors: John Arthur Notaras, New South Wales (AU); Angelo Lambrinos Notaras, New South Wales (AU)

Correspondence Address: ARENT FOX PLLC, 1050 CONNECTICUT AVENUE, N.W., SUITE 400, WASHINGTON, DC, 20036, US

(21) Appl. No.: 11/117,524

(22) Filed: Apr. 29, 2005

(30) Foreign Application Priority Data
Apr. 30, 2004 (AU) 2004 201 840
Apr. 30, 2004 (AU) 2004 201 836

(51) Int. Cl. A01D 34/00; A01D 15/00; A01D 21/00; A01D 23/00; A01D 27/00

(52) U.S. Cl. 172/17

(57) ABSTRACT

A cutter guard in the form of housing (8), enclosing the volume generated by the rotating cutter blades (5) of a lawn edge trimmer (1, 51), golf bunker trimmer or like cutting implement is disclosed. The housing (8) is provided with at least one viewing port (20, 21) through which the plane of rotation (15) of the cutter blades (5) can be observed by the operator. To prevent egress of cutting debris, each viewing port (20, 21) is occluded by means of either transparent material or mesh material. A supporting wheel arrangement for a golf bunker edge trimmer (51) is also disclosed. The support wheel (66) is provided with a coaxial disc (60) which engages the grass (61) adjacent the edge (53) of the bunker (54). The disc (60) prevents the wheel (56) and trimmer (51) slipping downhill towards the bunker (54) whilst traversing steeply sloping grass uphill of the bunker. Dual wheels (66) and an independently rotating disc (52) are also disclosed.

### FIELD OF THE INVENTION

The present invention relates to cutter guards and, in particular, cutter guards for a lawn edge trimmer, golf bunker trimmer, or like cutting implement.

### BACKGROUND ART

U.S. Pat. No. 5,826,667 granted to the present applicants, discloses a lawn edge trimmer or cutting implement which enables the grass growing adjacent to formed edges, such as concrete curves, footpaths (or sidewalks as they are known in the USA) and the like, to be cut or trimmed so that the grass does not overhang or overgrow the formed edge.

In order for the lawn edge trimmer to effectively trim the edges of bunkers used in golf courses, it is necessary for the trimmer to be fitted with a longer cutting blade. For example, the 10.5 inch (267 mm) blade conventionally used is replaced by a 17.25 inch (438 mm) blade. This has the consequence that the overall size and diameter of the cutter guard housing must be increased to accommodate the increased length of the cutter blade.

Two operational consequences flow from these changes. Firstly, the increased size of the cutter guard housing makes the accurate guiding of the entire implement more difficult since the operator's previous view is impaired by the bulk of the cutter guard housing. Secondly, the longer blade length magnifies any small angular deviation from the best cutting angle at which the device should be held. That is, small deviations from the best cutting angle using the shorter length blade result in only minor departures from the ideal result which are not noticeable. However, with the longer cutter blade the same small deviations result in unacceptably large deviations from the ideal result which are noticeable and thus unacceptable.

It is well known that golf courses are highly manicured expanses of lawn where the condition of the grass is of utmost importance to the playing of the game. Golf bunkers are positioned close to the green on many holes and are often positioned on relatively steeply sloping ground immediately in front of the green so as to present a hazard for the golfers playing that particular hole.

The grass of the fairway grows to the edge of the bunker and must be cut or trimmed to generate an aesthetically pleasing vertical wall at the bunker's edge. This cutting or trimming operation is a tedious and time consuming operating, often carried out by manually using hand held motorised brush cutters using a nylon filament cutter, or using a spade in order to cut runners, over-hanging grass, and the like from the edge of the bunker. In this connection the interface between the grass and sand can vary between merely a small step and a substantial near vertical bank.

In particular, where the grass slopes downwardly towards the edge of the bunker, it is extremely difficult to operate any wheeled cutting implement on the grass by traversing the grass slope, without the implement also sliding downwardly and thereby misplacing the cutting blade or blades of the implement from an intended cutting position.

The present invention seeks to provide an improved apparatus and method which will assist in producing an improved result.

### SUMMARY OF THE INVENTION

In accordance with the first aspect of the present invention there is disclosed a cutter guard for a lawn edge trimmer, golf bunker trimmer, or like cutting implement, said guard comprising a housing substantially enclosing the volume generated by the implement's rotating cutter means save for an opening through which the cutter means project(s) to permit cutting to take place, wherein said housing includes at least one viewing port through which the operation of the plane of the cutter means can be observed by an operator.

In accordance with the second aspect of the present invention there is disclosed a method of guiding a lawn edge trimmer or like cutting implement along a formed edge, said method comprising the steps of:
(i) viewing the rotation of a rotatable cutter means of said implement through a viewing port in a cutter guard housing partially enclosing the plane of rotation of said cutter means, and
(ii) guiding said implement to keep the spacing between said plane of rotation and said formed edge substantially constant.

In accordance with a further aspect of the present invention there is disclosed a supporting wheel arrangement for golf bunker edge trimmers and like cutting implements, said arrangement comprising an axle, at least one ground engaging wheel having a wheel diameter and being rotatably mounted on said axle to support said implement, and a grass engaging rotatable disc mounted on said implement to engage grass covering said ground when said implement is supported by said wheel.

In accordance with another aspect of the present invention there is disclosed in a golf bunker edge trimmer or like cutting implement having at least one ground engaging wheel supporting said implement adjacent said edge, the improvement comprising a grass engaging rotatable disc mounted on said implement to engage grass covering said ground when said implement is supported by said wheel.

In accordance with a still further aspect of the present invention there is disclosed a method of traversing a sloping grass surface adjacent the edge of a golf bunker with an edge trimmer or like wheeled cutting implement, said method comprising the steps of:
(i) engaging said sloping grass surface with at least one ground engaging wheel to determine the location and depth of the trimming or cutting procedure, and
(ii) simultaneously engaging said sloping surface with a grass engaging rotatable disc whereby the inter-engagement of said grass and disc prevents transverse sliding of said implement down said sloping grass surface under the influence of gravity.

### BRIEF DESCRIPTION OF THE DRAWINGS

Preferred embodiments of the present invention will now be described with reference to the drawings in which:

FIG. 1 is a perspective view from the operator's left hand side of an edge trimmer having a cutter guard in accordance with a first embodiment,

FIG. 2 is a perspective view of the cutter guard of FIG. 1, when viewed from the rear,

FIG. 3 is a plan view of the cutter guard of FIG. 2,

FIG. 4 is a cross-sectional view taken along the line IV-IV of FIG. 3,

FIG. 5 is a perspective view from the bunker side of the edge trimmer of a second embodiment in operation,

FIG. 6 is a perspective view from the opposite side of the trimmer of FIG. 1,

FIG. 7 is a schematic end elevation showing the operation of a grass engaging disc,

FIG. 8 is a view similar to FIG. 2 but of a further embodiment incorporating dual wheels, and

FIG. 9 is a vertical cross-section through the dual wheels of FIG. 4.

### DETAILED DESCRIPTION OF BEST MODE

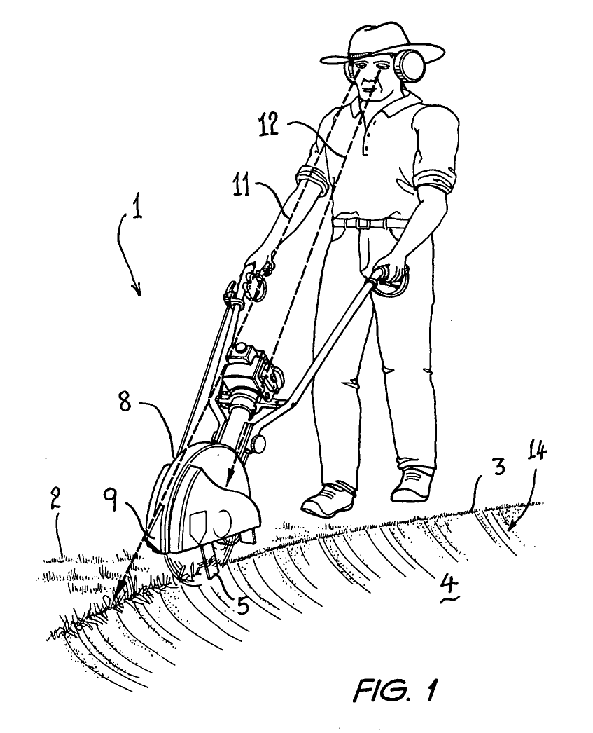

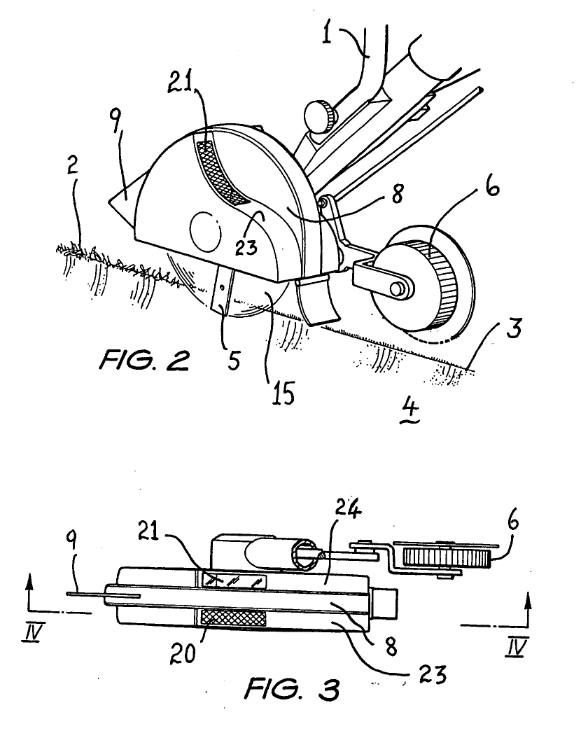

As seen in FIG. 1, an edge trimmer 1 generally of the form disclosed in U.S. Pat. No. 5,826,667 issued to the present applicants, is being used to trim grass 2 growing at the edge 3 of a bunker 4 filled with sand 14. The trimmer has a cutting blade or blades 5, and, as best seen in FIG. 2, is supported by a ground engaging wheel 6.

In order to protect the operator from injury, the cutting blades 5 are sheathed by a cutter guard housing 8 which, as disclosed in the abovementioned US patent, is provided with a sight guide 9 which is aligned with the plane of rotation 15 (as illustrated in FIG. 2) of the cutter blades 5.

In the prior art arrangements, the cutter housing 8 was entirely opaque and the operator utilized a first line of sight 11 (FIG. 1) based on the sight guide 9 to guide the path of the edge trimmer.

Such a line of sight was adequate for trimming under many circumstances, especially grass growing against a formed concrete kerb, for example, where the slight impact of the blade 5 on the vertical edge of the kerb could be sensed by the operator. However, such a sensory mechanism is not available to the operator where, for example, a golf bunker 4 is to be trimmed.

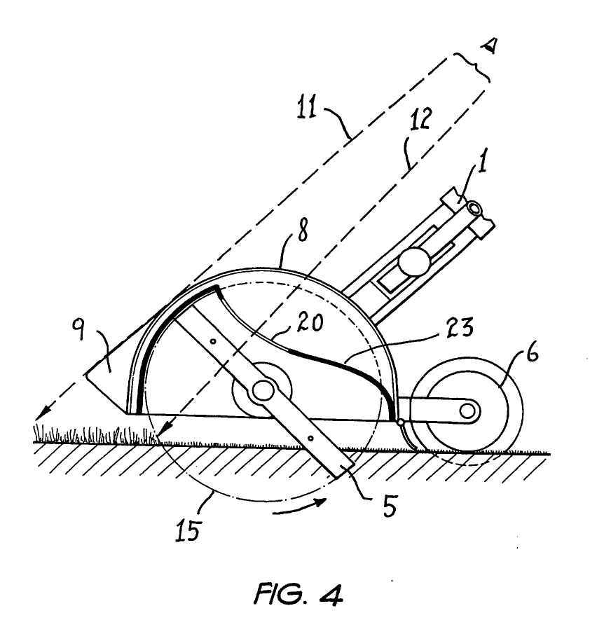

In accordance with the first embodiment of the present invention, in order to overcome this lack of sensory perception at least one, and preferably two, viewing ports 20, 21 (FIG. 2) are located one to either side of the plane 15 of rotation of the cutting blade 5. As best seen in FIGS. 2 and 3, the viewing ports 20, 21 are provided on a corresponding inclined portion 23, 24 which is arranged so that the viewing ports 20, 21 are substantially perpendicular to a second line of sight 12 (FIGS. 1 and 4). Because there are two viewing ports 20, 21 there are two corresponding second lines of sight which each pass through the corresponding viewing port and enable the plane 15 of rotation of the cutting blade 5 to be viewed during the cutting operation. In this way, both the grass 2 at the edge 3 of the bunker 4, and the sand 14 lying adjacent the edge 3 are able to be viewed simultaneously. This means that the handles of the trimmer 1 can be used to steer the wheel 6 parallel to the edge 4. In this way a smooth edge 3 can be created by trimming the grass 2.

The preferred direction of rotation of the cutting blade 5 is anti-clockwise as seen in FIG. 4. As a consequence the second line of sight 12 is directed at the point where the blade 5 strikes the ground surface. This is the most desirable point to watch in order to guide the device 1 accurately.

Furthermore, any loose debris generated by the cutting action moves downwardly from this point of contact and therefore moves away from the viewing port(s) 20, 21. As a result, substantially no debris moving with any appreciable velocity comes into contact with the viewing port. Thus the viewing port in its simplest form can be an opening. However, as a safety measure, the viewing port is preferably covered with mesh or a transparent window.

In the embodiment illustrated in FIGS. 1-4, the viewing port 20 is fabricated from fine metal mesh whilst the viewing port 21 is fabricated from clear plastics material. The metal mesh, or a strip of clear plastics material can be placed over a moulded aperture in the housing 8 which forms the corresponding viewing port. Alternatively, the viewing port 21 can be fabricated simultaneously during the moulding procedure used to mould the cover guard housing 8. It will be apparent to those skilled in the art that, if necessary, the interior surface of each of the viewing ports 20, 21 can be cleaned from time to time when the cutting blades 5 are not rotating. This ensures that the interior surface of viewing ports 20, 21 are not obscured by any debris which may be generated by the cutting action.

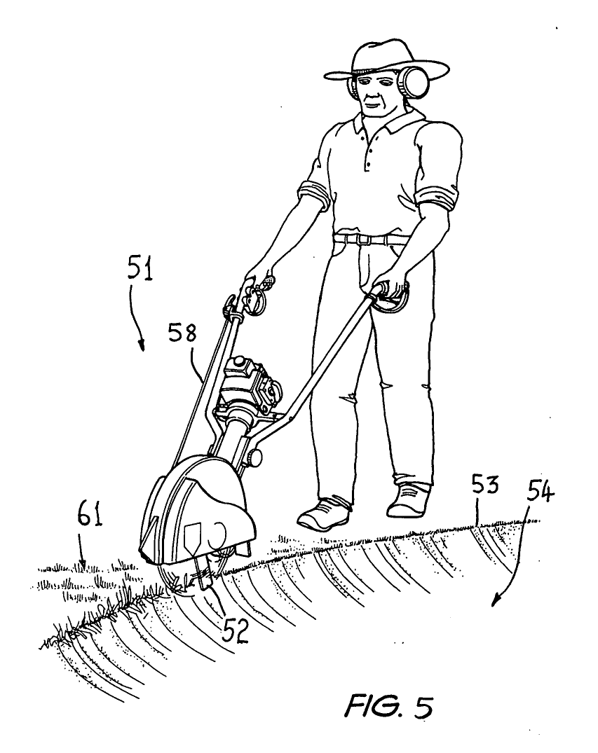

Turning now to FIGS. 5-7, the second embodiment of the present invention is applicable to an edge trimmer 51 of the general type disclosed in the abovementioned U.S. Pat. No. 5,826,667. However, the present invention is also applicable to other types of edge trimmers including those with 3 or 4 wheels. The trimmer 51 has a long cutting blade 52 (eg 17.25 inches or 438 mm in length) and is being used to trim the peripheral edge 53 of a bunker 54.

As best seen in FIG. 6, the trimmer 51 is provided with a ground engaging support wheel 56 which is mounted on a pivoted arm 57 which constitutes part of a depth of cut adjustment mechanism 58.

Mounted on the same axle adjacent to the wheel 56 is a thin metal disc 60 which has a diameter slightly larger (typically by approximately 10 mm) than the diameter of the wheel 56. As seen in FIG. 6, the disc 60 engages, but does not damage, the grass 51 over which the wheel 56 rolls.

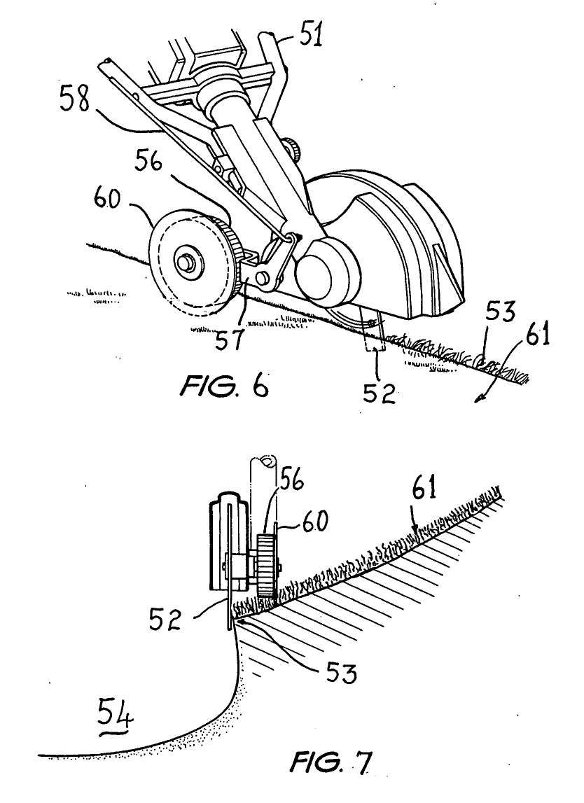

The disc 60 is particularly important where the grass 51 slopes relatively steeply towards the bunker 54. In this circumstance, as illustrated in FIG. 7, in the absence of the disc 60, the support wheel 56 would slide in a direction approximately parallel to the longitudinal axis of its axle, thereby resulting in the trimmer 51 sliding sideways down the sloping grass surface 61 and into the bunker 54. However, the disc 60 which engages the grass 61 prevents this sideways motion and thus the trimmer 51 is able to be easily controlled by the operator. In particular, the operator can steer the trimmer 51 using its handles so that the support wheel 56 follows the periphery of the bunker accurately thereby enabling the cutting blade 52 to accurately trim the edge 53 of the bunker 54.

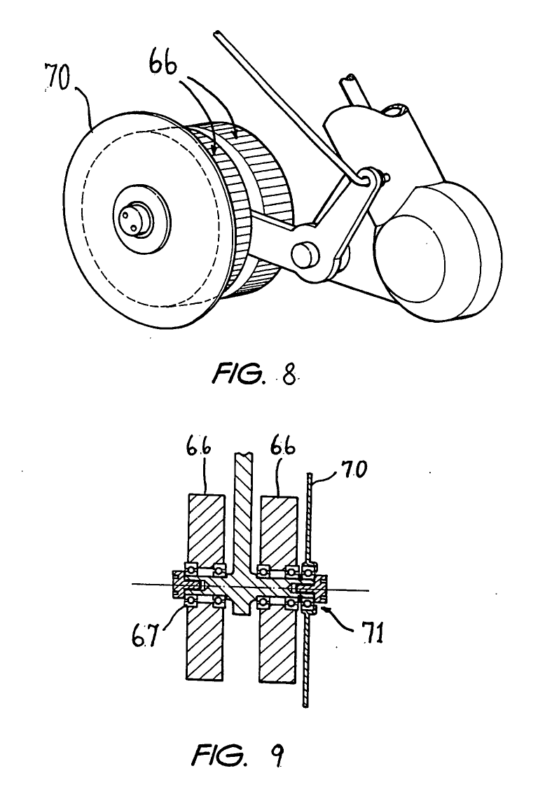

Turning now to FIGS. 8 and 9, there is illustrated therein a further embodiment of the present invention in which the trimmer 51 is provided with dual wheels 66, each of which are mounted on their own ball bearings 67 and an independently mounted disc 70 is likewise mounted on ball bearings 71. An advantage of having the disc 70 independently rotatable relative to the adjacent wheel 66 is that this arrangement is easier to push over, and manoeuvre over, the grass 61 adjacent the bunker 54.

The foregoing describes only some embodiments of the present invention and modifications, obvious to those skilled in the art, can be made thereto without departing from the scope of the present invention. For example, fiberglass mesh and fused plastics mesh can be used instead of woven metal mesh for the viewing ports since they equally prevent egress of debris via the viewing ports. Further, the disc can be formed as an annulus and can be attached directly to the wheel. Alternatively, the disc can be formed with radially extending protrusions (in a manner similar to a soil aerator), the protrusions extending beyond the rim of the wheel.

In addition, the disc 60, 70 can have a smaller diameter than the adjacent wheel and be positioned on a stub axle extending from the wheel. In this way the disc engages the grass 61 a short distance uphill from the wheel.

Similarly, it is not necessary for the disc 60, 70 to be mounted adjacent the wheel. For example, the disc 60, 70 can be mounted from a stub axle which extends from the frame of the edger. Such a stub axle can be positioned between the leading wheel(s) and trailing wheel(s) of edgers having 3 or 4 wheels.

Furthermore, although the genesis of the invention is golf bunkers, the invention is equally applicable to similar structures such as garden beds adjacent lawns and not having a paving edge, or similar boundary.

The term “comprising” (and its grammatical variations) as used herein is used in the inclusive sense of “having” or “including” and not in the exclusive sense of “consisting only of”.

1. A cutter guard for a lawn edge trimmer, golf bunker trimmer, or like cutting implement, said guard comprising a housing substantially enclosing the volume generated by the implement's rotating cutter means save for an opening through which the cutter means project(s) to permit cutting to take place, wherein said housing includes at least one viewing port through which the operation of the cutter means can be observed by an operator.

2. The guard as claimed in claim 1 and having a pair of said viewing ports.

3. The guard as claimed in claim 2 wherein said ports are located one to either side of said plane of rotation.

4. The guard as claimed in claim 1 wherein the, or each, said viewing port comprises an aperture in said housing.

5. The guard as claimed in claim 1 wherein the, or each, said viewing port substantially prevents the egress of cutting debris from said housing.

6. The guard as claimed in claim 5 wherein said aperture is occluded with a fine mesh.

7. The guard as claimed in claim 6 wherein said mesh is selected from the group consisting of woven metal mesh, fiberglass mesh, and fused plastics mesh.

8. The guard as claimed in claim 1 wherein the, or each, said viewing port comprises a transparent window.

9. The guard as claimed in claim 8 wherein said housing and the, or each, said viewing port are all formed from plastics material.

10. The guard as claimed in claim 1 wherein the, or each, said port is substantially planar and is located relative to said guard so as to be substantially normal to the operator's line of sight.

11. A supporting wheel arrangement for golf bunker edge trimmers, and like cutting implements, said arrangement comprising an axle, at least one ground engaging wheel having a wheel diameter and being rotatably mounted on said axle to support said implement, and a grass engaging rotatable disc mounted on said implement to engage grass covering said ground when said implement is supported by said wheel.

12. The arrangement as claimed in claim 11 wherein said implement has a frame and said disc is supported by said frame.

13. The arrangement as claimed in claim 12 wherein the diameter of said disc is less than that of said wheel.

14. The arrangement as claimed in claim 12 wherein said wheel and disc are not co-axial.

15. The arrangement as claimed in claim 11 wherein said disc is mounted adjacent to, and substantially co-axial with, said wheel and has a diameter greater than said wheel diameter.

16. The arrangement as claimed in claim 15 wherein said disc is fixed to, and rotates with, the adjacent wheel.

17. The arrangement as claimed in claim 15 wherein said disc is independently rotatable relative to the adjacent wheel.

18. The arrangement as claimed in claim 16 wherein said disc is rotatably mounted on said axle.

19. The arrangement as claimed in claim 11 wherein dual ground engaging wheels are mounted on said axle.

20. In a golf bunker edge trimmer, lawn edge trimmer, or like cutting implement having at least one ground engaging wheel supporting said implement adjacent said edge, the improvement comprising a grass engaging rotatable disc mounted on said implement to engage grass covering said ground when said implement is supported by said wheel.

21. The improvement as claimed in claim 20 wherein said implement has a frame and said disc is supported by said frame.

22. The improvement as claimed in claim 21 wherein the diameter of said disc is less than that of said wheel.

23. The improvement as claimed in claim 20 wherein said wheel and disc are not co-axial.

24. The improvement as claimed in claim 20 wherein said disc is mounted adjacent to, and substantially co-axial with, said wheel and has a diameter greater than said wheel diameter.

25. The improvement as claimed in claim 24 wherein said disc is fixed to, and rotates with, said adjacent wheel.

26. The improvement as claimed in claim 25 wherein said disc is independently rotatable relative to said adjacent wheel.

27. The improvement as claimed in claim 25 wherein said disc is rotatably mounted on said axle.

28. The improvement as claimed in claim 20 wherein said at least one ground engaging wheel comprises a pair of ground engaging wheels.

29. A method of guiding a lawn edge trimmer, golf bunker trimmer, or like cutting implement along a formed edge, said method comprising the steps of:
(i) viewing the rotation of a rotatable cutter means of said implement through a viewing port in a cutter guard housing partially enclosing the plane of rotation of said cutter means, and
(ii) guiding said implement to keep the spacing between said plane of rotation and said formed edge substantially constant.

30. The method as claimed in claim 29 including the further step of:
(iii) adjusting the depth of cut whilst keeping said spacing substantially constant.

31. A method of traversing a sloping grass surface adjacent the edge of a golf bunker with an edge trimmer, golf bunker trimmer, or like wheeled cutting implement, said method comprising the steps of:
(i) engaging said sloping grass surface with at least one ground engaging wheel to determine the location and depth of the trimming or cutting procedure, and
(ii) simultaneously engaging said sloping surface with a grass engaging rotatable disc whereby the inter-engagement of said grass and disc prevents transverse sliding of said implement down said sloping grass surface under the influence of gravity.

32. The method as claimed in claim 31 including the further step of:
(iii) steering said ground engaging wheel(s) around the periphery of said bunker to thereby circumscribe said bunker.

33. The method as claimed in claim 31 including the further step of:
(iv) making the diameter of said disc larger than the diameter of said wheel.

34. The method as claimed in claim 31 including the further step of:
(v) making the diameter of said disc smaller than the diameter of said wheel.
